(19) United States
(12) Patent Application Publication
(10) Pub. No.: US 2024/0413890 A1
(43) Pub. Date: Dec. 12, 2024

(54) LOCATING A SATELLITE IN LOW-EARTH ORBIT

(71) Applicant: IRIDIUM SATELLITE LLC, McLean, VA (US)

(72) Inventor: Ryan SHEPPERD, Leesburg, VA (US)

(73) Assignee: IRIDIUM SATELLITE LLC, McLean, VA (US)

(21) Appl. No.: 18/739,839

(22) Filed: Jun. 11, 2024

Related U.S. Application Data
(63) Continuation of application No. 18/234,604, filed on Aug. 16, 2023, now abandoned.
Application No. 18/234,604 is a continuation of application No. 18/159,641, filed on Jan. 25, 2023, now abandoned.
Application No. 18/159,641 is a continuation of application No. 17/532,760, filed on Nov. 22, 2021, now abandoned.
Application No. 17/532,760 is a continuation of application No. 16/247,388, filed on Jan. 14, 2019, now abandoned.
(60) Provisional application No. 62/617,287, filed on Jan. 14, 2018.

(51) Int. Cl. H04B 7/185; H04B 7/195

(52) U.S. Cl. CPC H04B 7/18513; H04B 7/195

(57) ABSTRACT

According to one implementation of the disclosure, a computer-implemented method of operating a feeder link terminal to locate a satellite in low-Earth orbit includes accessing predicted location information for a satellite in low-Earth orbit and determining an initial position at which to start a scan for the satellite. In addition, the method includes defining a substantially ellipsoidal region to scan for the satellite that includes the initial position, that has a long axis that corresponds to a predicted track of the satellite relative to the feeder link terminal, and that has a shorter axis that corresponds to potential cross-track error of the predicted track of the satellite. The method further includes causing the feeder link terminal to scan the ellipsoidal region for the satellite starting from the initial position.

### CROSS-REFERENCE TO RELATED APPLICATION

This application is a continuation of U.S. patent application Ser. No. 18/234,604 filed Aug. 16, 2023; which is a continuation of U.S. patent application Ser. No. 18/159,641 filed Jan. 25, 2023, now abandoned; which is a continuation of U.S. patent application Ser. No. 17/532,760 filed Nov. 22, 2021, now abandoned; which is a continuation of U.S. patent application Ser. No. 16/247,388 filed Jan. 14, 2019, now abandoned; which claims the benefit of U.S. Provisional Patent Application No. 62/617,287 filed Jan. 14, 2018. The entire disclosures of each of which are incorporated herein by reference in their entirety.

### TECHNICAL FIELD

This disclosure relates generally to locating a satellite and, more particularly, to operating a feeder link terminal or Earth terminal to locate a satellite in low-Earth orbit.

### SUMMARY

According to one implementation of the disclosure, a computer-implemented method of operating a feeder link terminal to locate a satellite in low Earth orbit includes accessing predicted location information for a satellite in low-Earth orbit and determining an initial position at which to start a scan for the satellite. In addition, the method includes defining a substantially ellipsoidal region to scan for the satellite that includes the initial position, that has a long axis that corresponds to a predicted track of the satellite relative to the feeder link terminal, and that has a shorter axis that corresponds to potential cross-track error of the predicted track of the satellite. The method further includes causing the feeder link terminal to scan the ellipsoidal region for the satellite starting from the initial position.

Other features and advantages will be apparent to persons of ordinary skill in the art from the following detailed description and the accompanying drawings. Implementations described herein, including the above-described implementation, may include a method or process, a system, or computer-readable program code embodied on computer-readable media.

### BRIEF DESCRIPTION OF THE DRAWINGS

FIG. 1 is a diagram that illustrates an example of an ellipsoidal region within which a LEO satellite likely may be located shortly after deployment.

FIG. 2 is a diagram that illustrates an example of a scan pattern that may be employed in an attempt to locate a LEO satellite shortly after deployment.

FIGS. 3 and 4A are flowcharts that illustrate examples of processes for scanning for LEO satellites.

FIG. 4B is a flowchart that illustrates one example of a process for determining a time offset for a scan for a LEO satellite.

FIG. 4C is a flowchart that illustrates one example of a process for determining an azimuth and/or elevation offset for a scan for a LEO satellite.

### DETAILED DESCRIPTION

Shortly after new satellite vehicles (“satellites” or “SVs”) are deployed from a rocket, the locations of the freshly deployed satellites may not be known precisely, especially when the satellites are deployed into low-Earth orbit (“LEO”). For any of a number of different reasons (e.g., launch errors, missed burns, missed attitude recovery thrusting, etc.), there may be rather significant error between the expected position of a satellite and the actual position of the satellite. Feeder link terminals (“FLTs”) or other Earth terminals looking to synchronize with a satellite shortly after launch, therefore, need to be able to effectively and efficiently scan a region of the sky to locate and then synchronize with and track the satellite. FLTs commonly may use a so-called spiral scan function to attempt to locate and synchronize with a satellite. However, a spiral scan function may not be terribly effective for locating LEO satellites, particularly shortly after deployment, and/or compensating for potential errors associated with certain launch scenarios.

Accordingly, new scan techniques are disclosed herein that may be better suited for locating LEO satellites, particularly shortly after deployment, and/or compensating for potential errors associated with certain launch scenarios. Among other features, these scan techniques may employ an approach that recognizes that the unknown location of a LEO satellite shortly after deployment may be most likely to fall within a long ellipsoidal region. Consequently, the scan techniques disclosed herein may use timing, azimuth, and/or elevation offsets to scan for a satellite in a long ellipsoidal pattern. Additionally or alternatively, the scan techniques disclosed herein may adjust the passbands of one or more FLT modems according to the area currently being scanned and/or the scan techniques disclosed herein may employ other optimizations at the modem/receiver level intended to facilitate quick acquisition of a satellite. As a result, the scan techniques disclosed herein may be able to accommodate Doppler error and other issues without having to employ an extra-wide passband, which could result in greater noise in the system and interfere with the desire to achieve a quick acquisition.

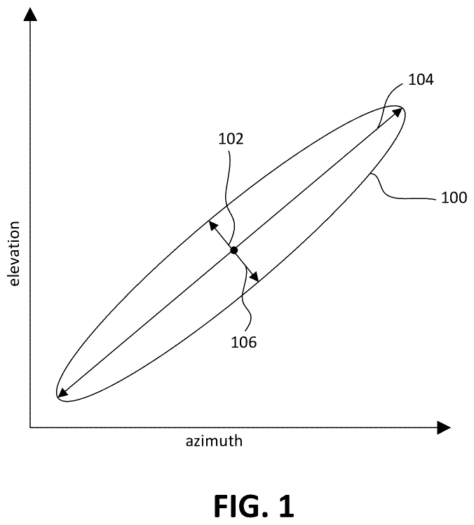

FIG. 1 is a diagram that illustrates one example of an ellipsoidal region 100 within which a LEO satellite likely may be located shortly after deployment. As illustrated in FIG. 1, the center 102 of the ellipsoid may represent the expected position of the satellite. In some implementations, the expected position of the satellite may be determined based on the known or planned position at which the satellite was deployed, planned orbit of the satellite following deployment, and/or the amount of time since deployment.

As further illustrated in FIG. 1, the long axis 104 of the ellipsoidal region 102 represents so-called along track error of the satellite. For example, axis 104 may represent the expected path of the satellite and any displacement from the center 102 along axis 104 may represent a timing error. Displacement in the positive direction along axis 104 may represent that the satellite is further along its expected path than expected while displacement in the negative direction along axis 104 may represent that the satellite is not as far along its expected path as expected. As also illustrated in FIG. 1, a short axis 106 of the ellipsoidal region 102 represents so-called cross-track error of the satellite. For example, such cross-track error may be due to elevation and/or azimuth errors between the expected location of the satellite and the actual location of the satellite.

According to techniques disclosed herein, the objective of a scan for a satellite may be to focus on scanning for the satellite within the ellipsoidal region 100 while avoiding or spending little time/effort scanning outside of ellipsoidal region 100. In some implementations, timing, azimuth, and elevation offsets may be applied to the expected position of a satellite to scan for the satellite in an ellipsoidal pattern as illustrated in FIG. 1. For example, in some particular implementations, such a scan for a satellite may be initiated at the expected position of the satellite (e.g., at or near the center 102 of the ellipsoidal region) and timing, elevation, and/or azimuth offsets may be applied to the expected position of the satellite to cause the scan to progress in a positive direction relative to axis 104 (e.g., to scan the “front” half of the ellipsoidal region). If the scan does not successfully locate the satellite, the scan may return to the expected position of the satellite, and timing, elevation, and/or azimuth offsets again may be applied to the expected position of the satellite to case the scan to progress in a negative direction relative to axis 104.

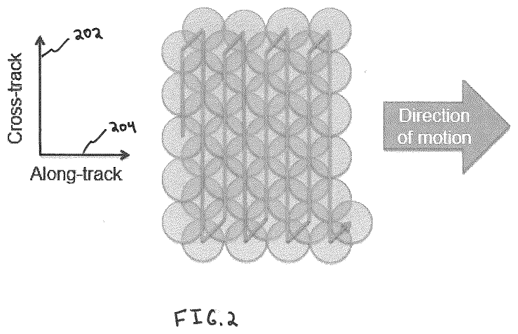

FIG. 2 is a diagram that illustrates one example of a scan pattern that may be employed in an attempt to locate a LEO satellite shortly after deployment. As illustrated in FIG. 2, horizontal axis 204 represents so-called along track error and vertical axis 202 represents so-called cross-track error. The intersection of horizontal axis 204 and vertical axis 202 may represent the expected position of the satellite. Timing offsets may be applied to the expected position of the satellite to scan along axis 204 and azimuth and/or elevation offsets may be applied to the expected position of the satellite to scan along axis 202.

As illustrated in FIG. 2, individual circles may represent individual areas within the ellipsoidal region of the scan at which the FLT scans for the satellite. For example, each individual circle may represent a specific combination of discrete timing, azimuth, and/or elevation offsets. Each individual circle may represent the beam width of the FLT, which, in some implementations, may be 0.2 degrees. As described above in connection with FIG. 1 and as illustrated in FIG. 2, in some implementations, a scan for a satellite may be initiated at or near the expected position of the satellite and then proceed in a forward direction along the expected path of the satellite. Although not illustrated in FIG. 2, if the satellite is not located, the scan may return to or near the expected location of the satellite and then proceed in a backward direction along the expected path of the satellite.

In some implementations, the FLT may stop and dwell in each individual area while it scans for a satellite. In other implementations, the FLT may dwell only in a subset of less than all of the areas. For example, in some particular implementations, the FLT may dwell only in areas that are along horizontal axis 204 and/or at the boundary of the ellipsoidal region.

As illustrated in FIG. 2, a scan may employ multiple different azimuth and/or elevation offsets for each timing offset value. Furthermore, although not illustrated in FIG. 2, the number of different azimuth and/or elevation offsets for each timing offset value may vary, for example, to form an ellipsoidal region for the scan.

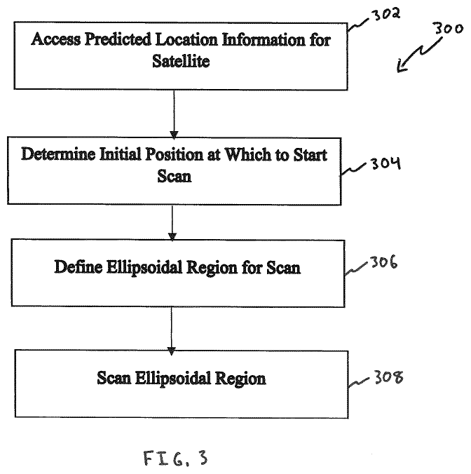

FIG. 3 is a flowchart 300 that illustrates an example of a process for scanning for a LEO satellite. The process illustrated in FIG. 3 may be employed to operate a feeder link terminal to scan for a LEO satellite.

At block 302, predicted location information for the satellite is accessed. For example, in some implementations, predicted location information may be available, for example, from the launch provider, based on the planned or actual deployment of the satellite, the planned orbit of the satellite following deployment, and/or the amount of time since deployment.

Based on the predicted location information for the satellite, at block 304, an initial position at which to start the scan is determined and, at block 306, an ellipsoidal region to scan is defined. In some implementations, the initial position at which to start the scan may be determined to be the (or near the) predicted position of the satellite at the time at which the scan is to start and/or the initial position at which to start the scan may be defined as the center of the ellipsoidal region to scan. Additionally or alternatively, in some implementations, the ellipsoidal region may have a relatively long axis representing the predicted path of the satellite and a shorter axis representing so-called cross-track error.

At block 308, the ellipsoidal region is scanned for the satellite. In some implementations, the scan may start at the determined initial position and proceed in a positive direction along the predicted path of the satellite to scan the front half of the ellipsoidal region and, if the satellite is not located, return to (or near) the determined initial position and then scan in a negative direction along the predicted path of the satellite to scan the back half of the ellipsoidal region. In some implementations, the scan may be stopped without scanning the entire ellipsoidal region if the satellite is located before the entire ellipsoidal region has been scanned. For example, if a signal is received by the feeder link terminal that is within a range of frequencies around the expected frequency of the satellite's downlink signal and the received signal exceeds a predefined power threshold, it may be determined that the satellite has been located, and the feeder link terminal may attempt to synchronize with the satellite and start autotracking the satellite. In some implementations, if the entire ellipsoidal region is scanned and the satellite is not located, the process illustrated in the flowchart 300 of FIG. 3 may be repeated, for example, to scan a new ellipsoidal region for the satellite.

In some implementations, the passband of a filter used to filter signals received by the feeder link terminal may be modified dynamically based on the particular area within the ellipsoidal region being scanned at any given point in time to accommodate potential Doppler error in the satellite's downlink signal based on the position of the satellite (e.g. the area being scanned).

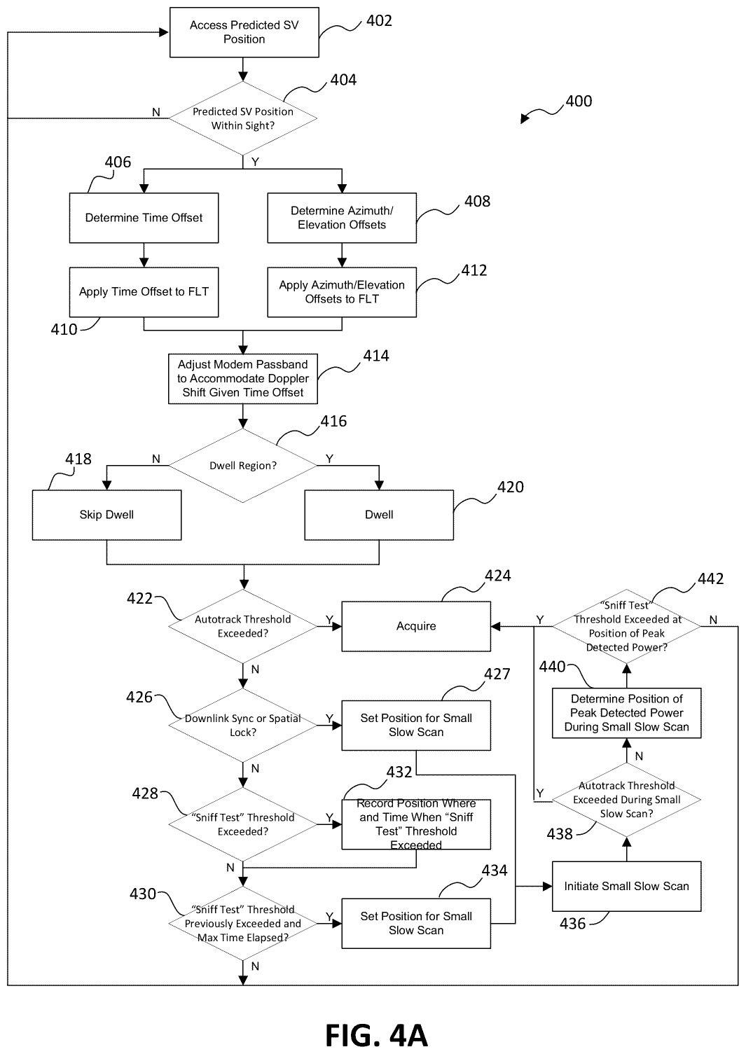

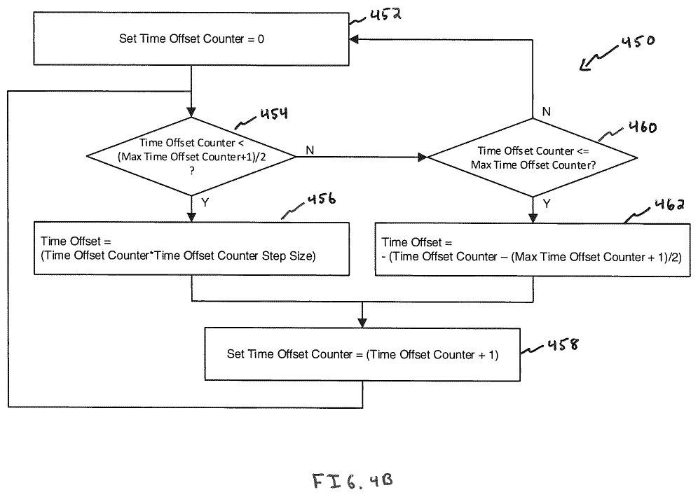

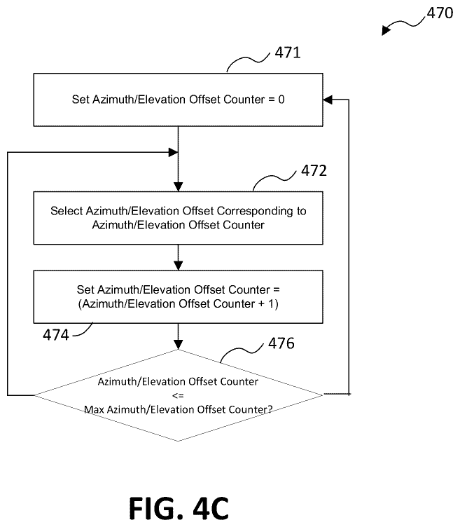

FIG. 4A is a flowchart 400 that illustrates an example of a process for scanning for a LEO satellite. The process illustrated in FIG. 4 may be employed to operate a feeder link terminal to scan for a LEO satellite.

At block 402, predicted satellite position information is accessed and, at block 404, a determination is made as to whether the satellite is within sight of the feeder link terminal (e.g., a line of sight exists between the satellite and the feeder link terminal such that the satellite and feeder link terminal can exchange wireless signals) based on the predicted satellite position information. If it is determined that the satellite is not within sight of the feeder link terminal, the process returns to block 402.

Alternatively, if it is determined that the satellite is within sight of the feeder link terminal, a time offset is determined at block 406 and an azimuth and/or elevation offset is determined at block 408. (One example of a process for determining a time offset is described below in connection with FIG. 4B, and one example of a process for determining an azimuth and/or elevation offset is described below in connection with FIG. 4C. It will be appreciated that the various different combinations of time, azimuth, and/or elevation offsets may be selected to define an ellipsoidal region to scan for the satellite as described throughout this disclosure.) Thereafter, the determined time offset is applied to the feeder link terminal scan at block 410 and the determined azimuth and/or elevation offset(s) is applied to the feeder link terminal scan at block 412. In addition, at block 414, the passband of a feeder link terminal filter (e.g., a filter in the feeder link terminal's modem) may be adjusted to accommodate a potential Doppler shift to the satellite's downlink signal (e.g., based on the applied time offset).

At block 416, a determination is made as to whether the applied combination of time, azimuth, and/or elevation offsets for the scan corresponds to a dwell region for the scan. If it is determined that the applied combination of time, azimuth, and/or elevation offsets do not correspond to a dwell region for the scan, at block 418, a dwell may be skipped, and, in some implementations, the feeder link terminal may scan continuously through the applied combination of time, azimuth, and/or elevation offsets. Alternatively, if it is determined that the applied combination of time, azimuth, and/or elevation offsets do correspond to a dwell region for the scan, at block 420, the scan may dwell at the applied combination of time, azimuth, and/or elevation offsets. For example, in some implementations, the scan may dwell at the applied combination of time, azimuth, and/or elevation offsets for approximately 0.1 seconds.

At block 422, a determination is made as to whether a signal received by the feeder link terminal during the scan is within a defined range of expected frequencies for the downlink signal from the satellite and, if so, whether such signal exceeds a predefined power threshold referred to in FIG. 4A as the “autotrack threshold.” If it is determined that a signal received by the feeder link terminal during the scan is within the defined range of expected frequencies and exceeds the predefined autotrack power threshold, it may be determined that the satellite has been located and, at block 424, the feeder link terminal may attempt to synchronize with (or acquire) the satellite and begin to autotrack the satellite.

Alternatively, if it is determined that no signal received by the feeder link terminal during the scan is within the defined range of expected frequencies and exceeded the predefined autotrack power threshold, the process continues to block 426, where a determination is made as to whether a downlink synchronization or spatial lock on the satellite has been achieved. If it is determined that either downlink synchronization or spatial lock has been achieved, the process proceeds to block 427. At block 427, the position at which downlink synchronization or spatial lock was achieved is set as the position for which to perform a small slow scan, and the process proceeds to block 436, which is described further below. Alternatively, if it is determined at block 426 that neither downlink synchronization nor spatial lock has been achieved, the process continues to block 428.

At block 428, a determination is made as to whether a signal received by the feeder link terminal during the scan is within a defined range of expected frequencies for the downlink signal from the satellite and, if so, whether such signal exceeds a predefined power threshold that is less than the autotrack power threshold and that is referred to in FIG. 4A as the “sniff test” threshold. If it is determined that no signal received by the feeder link terminal during the scan is within the defined range of expected frequencies and exceeded the predefined sniff test power threshold, the process proceeds to block 430. Alternatively, if it is determined that a signal received by the feeder link terminal during the scan is within the defined range of expected frequencies and exceeds the predefined sniff test power threshold, the time and position at which such signal was received is recorded at block 432 and the process then proceeds to block 430.

At block 430, determinations are made as to whether (i) a signal has been received during the scan that was within the defined range of expected frequencies and exceeded the predefined sniff test power threshold, and (ii) a predefined amount of time (e.g., the time allocated to scan the ellipsoidal region) has elapsed. If either determination is negative, the process returns to block 404 and repeats. Alternatively, if both determinations are positive, the process proceeds to block 434 where the position at which the signal that exceeded the predefined sniff test power threshold is set as the position for which to perform a small, slow scan, and the process then proceeds to block 436.

At block 436, the feeder link terminal initiates a small, slow scan for the satellite based on the position set at block 427 or block 434. At block 438, a determination is made as to whether a signal received by the feeder link terminal during the small, slow scan is within a defined range of expected frequencies for the downlink signal from the satellite and, if so, whether such signal exceeds the predefined autotrack power threshold. If so, it may be determined that the satellite has been located and, at block 424, the feeder link terminal may attempt to synchronize with (or acquire) the satellite and begin to autotrack the satellite.

Alternatively, if it is determined that the feeder link terminal has not received a signal during the small, slow scan that is within the range of expected frequencies for the downlink signal and that exceeds the predefined power autotrack power threshold, the process proceeds to block 440. At block 440, the position during the small, slow scan at which the highest-power signal within the range of expected frequencies for the downlink signal from the satellite was received is determined, and the process proceeds to block 442, where a determination is made as to whether the power of that signal exceeds the predefined sniff test power threshold. If so, it may be determined that there is a possibility that the satellite may be located at that position and the process proceeds to block 424, where the feeder link terminal attempts to synchronize with (or acquire) the satellite and begin to autotrack the satellite. Alternatively, if the power of the highest power signal within the range of expected frequencies for the downlink signal from the satellite received during the small, slow scan does not exceed the predefined sniff test power threshold, the process returns to block 404 and repeats.

FIG. 4B is a flowchart 450 that illustrates one example of a process for determining a time offset for a scan for a LEO satellite, for example as described above in connection with FIG. 4A. In some implementations, a number of time offsets and a corresponding time offset step size is predefined for a scan in connection with defining an ellipsoidal region within which to scan for a satellite. The process illustrated in the flowchart 450 of FIG. 4B may result in the selection of time offsets that cause the scan to scan the front half of the ellipsoidal region first before returning to the center of the ellipsoidal region and scanning the back half of the ellipsoidal region.

At block 452, a time offset counter is initialized by setting the time offset counter equal to zero. Thereafter, at block 454, a determination is made as to whether the time offset counter is less than one half of the sum of (i) the max time offset counter parameter (i.e., the predefined number of time offsets) and (ii) one. If so, the process proceeds to block 456, where the time offset is set to the value of the time offset counter multiplied by the predefined time offset step size for the scan. Thereafter, the process proceeds to block 458, where the time offset counter is incremented, followed by block 450, where the process repeats.

Alternatively, if at block 454, a determination is made that the time offset counter is greater than or equal to one half of the sum of (i) the max time offset counter parameter (i.e., the predefined number of time offsets) and (ii) one, the process proceeds to block 460. At block 460, a determination is made as to whether the time offset counter is less than or equal to the max time offset counter parameter (i.e., the predefined number of time offsets). If so, the process proceeds to block 462, where the time offset is set the negative of the difference of (i) the time offset counter and (ii) one half of the max time offset counter parameter plus one. Thereafter, the process proceeds to block 458, where the time offset counter is incremented, followed by block 450, where the process repeats.

FIG. 4C is a flowchart 470 that illustrates one example of a process for determining an azimuth and/or elevation offset for a scan for a LEO satellite, for example as described above in connection with FIG. 4A. In some implementations, an ordered set of azimuth and/or elevation offsets is predefined for a scan in connection with defining an ellipsoidal region within which to scan for a satellite. The process illustrated in the flowchart 470 of FIG. 4C may result in the selection of individual azimuth and/or elevation offsets from among such a predefined set.

At block 471, the azimuth/elevation offset counter is initialized by setting the azimuth/elevation offset counter equal to zero. Then, at block 472, the azimuth and/or elevation offsets corresponding to the value of the azimuth/elevation offset counter are selected from the predefined set. Thereafter, the azimuth/elevation offset counter is incremented at block 474. At block 476, a determination is made as to whether the azimuth/elevation offset counter is less then or equal to the maximum azimuth/elevation offset counter parameter (i.e., the number of azimuth and/or elevation offsets in the set). If so, the process returns to block 472 and repeats. If not, the process returns to block 471 and starts over.

While the techniques disclosed herein frequently are described in the context of locating LEO satellites shortly after deployment, the techniques disclosed herein also may be applied to searching for LEO satellites at any time and/or searching for satellites in non-LEO orbits, including, for example, geosynchronous and other orbits whether or not shortly after deployment of such satellites.

In particular implementations, the processes described herein may be implemented by a computer process loaded in memory and executed using one or more computer processors, for example, to control a feeder link terminal or Earth station to scan for a satellite. The computer-hardware implementing these processes may be located at or be part of such a feeder link terminal or Earth station.

Aspects of the present disclosure may be implemented entirely in hardware, entirely in software (including firmware, resident software, micro-code, etc.) or in combinations of software and hardware that may all generally be referred to herein as a “circuit,” “module,” “component,” or “system.” Furthermore, aspects of the present disclosure may take the form of a computer program product embodied in one or more machine-readable media having machine-readable program code embodied thereon.

Any combination of one or more machine-readable media may be utilized. The machine-readable media may be a machine-readable signal medium or a machine-readable storage medium. A machine-readable storage medium may be, for example, but not limited to, an electronic, magnetic, optical, electromagnetic, or semiconductor system, apparatus, or device, or any suitable combination of the foregoing. More specific examples (a non-exhaustive list) of such a machine-readable storage medium include the following: a hard disk, a random access memory (RAM), a read-only memory (ROM), an erasable programmable read-only memory (EPROM or Flash memory), an appropriate optical fiber with a repeater, an optical storage device, a magnetic storage device, or any suitable combination of the foregoing. In the context of this document, a machine-readable storage medium may be any tangible medium that can contain, or store, a program for use by or in connection with an instruction execution system, apparatus, or device, such as, for example, a microprocessor.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device. Program code embodied on a machine-readable signal medium may be transmitted using any appropriate medium, including but not limited to wireless, wireline, optical fiber cable, RF signals, etc., or any suitable combination of the foregoing.

Computer program code for carrying out operations for aspects of the present disclosure may be written in any combination of one or more programming languages, including object oriented programming languages, dynamic programming languages, and/or procedural programming languages.

The flowcharts and block diagrams in the figures illustrate examples of the architecture, functionality, and operation of possible implementations of systems, methods and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the blocks may occur out of the order illustrated in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and machine-readable instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

What is claimed is:

1. A computer-implemented method of operating a feeder link terminal to locate a satellite in low-Earth orbit, the method comprising:
accessing predicted location information for a satellite in low-Earth orbit;
based on the predicted location information for the satellite:
determining an initial position at which to start a scan for the satellite, and
defining a substantially ellipsoidal region, including the initial position, to scan for the satellite, a long axis of the ellipsoidal region corresponding to a predicted track of the satellite relative to the feeder link terminal and a shorter axis of the ellipsoidal region corresponding to potential cross-track error of the predicted track of the satellite; and
causing the feeder link terminal to scan the ellipsoidal region for the satellite, wherein the scan of the ellipsoidal region is started from the initial position.

2. The method of claim 1 further comprising:
processing signals received by the feeder link terminal while scanning through the ellipsoidal region;
as a consequence of processing signals received by the feeder link terminal while scanning through the ellipsoidal region:
detecting a signal within an expected frequency range of a downlink signal from the satellite while the feeder link terminal is scanning a particular area within the ellipsoidal region,
determining that the power of the detected signal within the expected frequency range of the downlink signal from the satellite exceeds a predefined power threshold level, and
determining that the satellite is located in the particular area within the ellipsoidal region as a consequence of having determined that the power of the detected signal exceeds the predefined power threshold level; and
as a consequence of having determined that the satellite is located in the particular area within the ellipsoidal region, causing the feeder link terminal to start tracking the satellite from the particular area within the ellipsoidal region.

3. The method of claim 1 further comprising:
processing signals received by the feeder link terminal while scanning through the ellipsoidal region;
as a consequence of processing signals received by the feeder link terminal while scanning through the ellipsoidal region, determining that no signals received by the feeder link terminal while scanning through the ellipsoidal region were both within an expected frequency range of a downlink signal from the satellite and had a power that exceeded a predefined power threshold; and
as a consequence of having determined that no signals received by the feeder link terminal while scanning through the ellipsoidal region were both within an expected frequency range of a downlink signal from the satellite and had a power that exceeded the predefined power threshold:
determining, based on the predicted location information for the satellite, a new position at which to start a new scan for the satellite,
defining, based on the predicted location information for the satellite, a new, substantially ellipsoidal region, including the new position, to scan for the satellite, and
causing the feeder link terminal to scan the new ellipsoidal region for the satellite.

4. The method of claim 1 further comprising:
for each of multiple different areas within the ellipsoidal region, determining a different range of frequencies around an expected frequency of a downlink signal from the satellite to account for an expected Doppler shift to the frequency of the downlink signal from the satellite if the satellite is in the corresponding area; and
while the feeder link scans through the different areas within the ellipsoidal region, modifying a passband of a receiver of the feeder link terminal according to the different frequency ranges determined for the different areas within the ellipsoidal region.

5. The method of claim 1, wherein:
defining the substantially ellipsoidal region to scan for the satellite includes:
defining a number of different areas within the ellipsoidal region that collectively form the ellipsoidal region; and
defining a subset of less than all of the different areas as areas within which the feeder link terminal shall dwell temporarily while scanning the ellipsoidal region for the satellite; and
causing the feeder link terminal to scan the ellipsoidal region for the satellite includes causing the feeder link terminal to dwell temporarily in areas within the defined subset while scanning the ellipsoidal region for the satellite.

6. The method of claim 5, wherein causing the feeder link terminal to scan the ellipsoidal region for the satellite includes causing the feeder link terminal to continuously scan through areas not within the defined subset while scanning the ellipsoidal region for the satellite.

7. The method of claim 1, wherein:
defining a substantially ellipsoidal region to scan for the satellite includes:
determining a set of timing offsets from the determined initial position representing different potential positions of the satellite along the predicted track of the satellite, and
determining a set of azimuth and elevation offsets representing different potential positions of the satellite off of the predicted track of the satellite; and
causing the feeder link terminal to scan the ellipsoidal region for the satellite includes applying the set of timing offsets and the set of azimuth and elevation offsets to cause the feeder link terminal to scan the ellipsoidal region for the satellite.

8. The method of claim 1, wherein:
defining a substantially ellipsoidal region to scan for the satellite includes defining a substantially ellipsoidal region with the initial position substantially at the center of the ellipsoidal region; and
causing the feeder link terminal to scan the ellipsoidal region for the satellite starting from the initial position includes:
causing the feeder link terminal to scan a front half of the ellipsoidal region starting from the initial position and scanning in a forward direction along the predicted track of the satellite, and
after completing the scan of the front half of the ellipsoidal region, returning to the initial position and scanning in a backward direction along the predicted track of the satellite.

9. A feeder link terminal system, comprising:
one or more processing elements; and
a non-transitory, computer-readable storage medium storing computer-readable instructions for operating the feeder link terminal system to locate a satellite in low-Earth orbit that, when executed by the one or more processing elements, cause the feeder link terminal system to:
access predicted location information for a satellite in low-Earth orbit;
based on the predicted location information for the satellite:
determine an initial position at which to start a scan for the satellite, and
define a substantially ellipsoidal region, including the initial position, to
scan for the satellite, a long axis of the ellipsoidal region corresponding to a predicted track of the satellite relative to the feeder link terminal and a shorter axis of the ellipsoidal region corresponding to potential cross-track error of the predicted track of the satellite; and
scan the ellipsoidal region for the satellite, wherein the scan of the ellipsoidal region is started from the initial position.

10. The feeder link terminal system of claim 9 wherein the computer-readable instructions for operating the feeder link terminal system to locate a satellite in low-Earth orbit stored by the non-transitory, computer-readable storage medium further include instructions that, when executed by the one or more processing elements, cause the feeder link terminal system to:
process signals received by the feeder link terminal while scanning through the ellipsoidal region;
as a consequence of processing signals received by the feeder link terminal while scanning through the ellipsoidal region:
detect a signal within an expected frequency range of a downlink signal from the satellite while the feeder link terminal is scanning a particular area within the ellipsoidal region,
determine that the power of the detected signal within the expected frequency range of the downlink signal from the satellite exceeds a predefined power threshold level, and
determine that the satellite is located in the particular area within the ellipsoidal region as a consequence of having determined that the power of the detected signal exceeds the predefined power threshold level; and
as a consequence of having determined that the satellite is located in the particular area within the ellipsoidal region, start tracking the satellite from the particular area within the ellipsoidal region.

11. The feeder link terminal system of claim 9 wherein the computer-readable instructions for operating the feeder link terminal system to locate a satellite in low-Earth orbit stored by the non-transitory, computer-readable storage medium further include instructions that, when executed by the one or more processing elements, cause the feeder link terminal system to:
process signals received by the feeder link terminal while scanning through the ellipsoidal region;
as a consequence of processing signals received by the feeder link terminal while scanning through the ellipsoidal region, determine that no signals received by the feeder link terminal while scanning through the ellipsoidal region were both within an expected frequency range of a downlink signal from the satellite and had a power that exceeded a predefined power threshold; and
as a consequence of having determined that no signals received by the feeder link terminal while scanning through the ellipsoidal region were both within an expected frequency range of a downlink signal from the satellite and had a power that exceeded the predefined power threshold:
determine, based on the predicted location information for the satellite, a new position at which to start a new scan for the satellite,
define, based on the predicted location information for the satellite, a new, substantially ellipsoidal region, including the new position, to scan for the satellite, and
scan the new ellipsoidal region for the satellite.

12. The feeder link terminal system of claim 9 wherein the computer-readable instructions for operating the feeder link terminal system to locate a satellite in low-Earth orbit stored by the non-transitory, computer-readable storage medium further include instructions that, when executed by the one or more processing elements, cause the feeder link terminal system to:
for each of multiple different areas within the ellipsoidal region, determine a different range of frequencies around an expected frequency of a downlink signal from the satellite to account for an expected Doppler shift to the frequency of the downlink signal from the satellite if the satellite is in the corresponding area; and
while the feeder link scans through the different areas within the ellipsoidal region, modify a passband of a receiver of the feeder link terminal according to the different frequency ranges determined for the different areas within the ellipsoidal region.

13. The feeder link terminal system of claim 9, wherein:
the computer-readable instructions that, when executed by the one or more processing elements, cause the feeder link terminal system to define the substantially ellipsoidal region to scan for the satellite include computer-readable instructions that, when executed by the one or more processing elements, cause the feeder link terminal system to:
define a number of different areas within the ellipsoidal region that collectively form the ellipsoidal region, and
define a subset of less than all of the different areas as areas within which the feeder link terminal shall dwell temporarily while scanning the ellipsoidal region for the satellite; and
the computer-readable instructions that, when executed by the one or more processing elements, cause the feeder link terminal system to scan the ellipsoidal region for the satellite include computer-readable instructions that, when executed by the one or more processing elements, cause the feeder link terminal system to dwell temporarily in areas within the defined subset while scanning the ellipsoidal region for the satellite.

14. The feeder link terminal system of claim 9, wherein:
the computer-readable instructions that, when executed by the one or more processing elements, cause the feeder link terminal system to define the substantially ellipsoidal region to scan for the satellite include computer-readable instructions that, when executed by the one or more processing elements, cause the feeder link terminal system to:
determine a set of timing offsets from the determined initial position representing different potential positions of the satellite along the predicted track of the satellite, and
determine a set of azimuth and elevation offsets representing different potential positions of the satellite off of the predicted track of the satellite; and
the computer-readable instructions that, when executed by the one or more processing elements, cause the feeder link terminal system to scan the ellipsoidal region for the satellite include computer-readable instructions that, when executed by the one or more processing elements, cause the feeder link terminal system to apply the set of timing offsets and the set of azimuth and elevation offsets to cause the feeder link terminal to scan the ellipsoidal region for the satellite.

15. The feeder link terminal system of claim 9, wherein:
the computer-readable instructions that, when executed by the one or more processing elements, cause the feeder link terminal system to define the substantially ellipsoidal region to scan for the satellite include computer-readable instructions that, when executed by the one or more processing elements, cause the feeder link terminal system to:
define a substantially ellipsoidal region to scan for the satellite includes defining a substantially ellipsoidal region with the initial position substantially at the center of the ellipsoidal region; and
the computer-readable instructions that, when executed by the one or more processing elements, cause the feeder link terminal system to scan the ellipsoidal region for the satellite include computer-readable instructions that, when executed by the one or more processing elements, cause the feeder link terminal system to:
scan a front half of the ellipsoidal region starting from the initial position and scanning in a forward direction along the predicted track of the satellite, and
after completing the scan of the front half of the ellipsoidal region, return to the initial position and scan in a backward direction along the predicted track of the satellite.

16. A non-transitory, computer-readable storage medium storing computer-readable instructions for locating a satellite in low-Earth orbit that, when executed by one or more processing elements, cause the processing elements to:
access predicted location information for a satellite in low-Earth orbit;
based on the predicted location information for the satellite:
determine an initial position at which to start a scan for the satellite, and
define a substantially ellipsoidal region, including the initial position, to scan for the satellite, a long axis of the ellipsoidal region corresponding to a predicted track of the satellite relative to the feeder link terminal and a shorter axis of the ellipsoidal region corresponding to potential cross-track error of the predicted track of the satellite; and
scan the ellipsoidal region for the satellite, wherein the scan of the ellipsoidal region is started from the initial position.

17. The computer-readable storage medium of claim 16, wherein the computer-readable instructions for locating a satellite in low-Earth orbit further include instructions that, when executed by the one or more processing elements, cause the processing elements to:
determine, for each of multiple different areas within the ellipsoidal region, a different range of frequencies around an expected frequency of a downlink signal from the satellite to account for an expected Doppler shift to the frequency of the downlink signal from the satellite if the satellite is in the corresponding area; and
while the feeder link scans through the different areas within the ellipsoidal region, modify a passband of a receiver of the feeder link terminal according to the different frequency ranges determined for the different areas within the ellipsoidal region.

18. The computer-readable storage medium of claim 16, wherein:
the computer-readable instructions that, when executed by the one or more processing elements, cause the one or more processing elements to define the substantially ellipsoidal region to scan for the satellite include computer-readable instructions that, when executed by the one or more processing elements, cause the one or more processing elements to:
define a number of different areas within the ellipsoidal region that collectively form the ellipsoidal region, and
define a subset of less than all of the different areas as areas within which the feeder link terminal shall dwell temporarily while scanning the ellipsoidal region for the satellite; and
the computer-readable instructions that, when executed by the one or more processing elements, cause the one or more processing elements to scan the ellipsoidal region for the satellite include computer-readable instructions that, when executed by the one or more processing elements, cause the processing elements to dwell temporarily in areas within the defined subset while scanning the ellipsoidal region for the satellite.

19. The computer-readable storage medium of claim 16, wherein:
the computer-readable instructions that, when executed by the one or more processing elements, cause the one or more processing elements to define the substantially ellipsoidal region to scan for the satellite include computer-readable instructions that, when executed by the one or more processing elements, cause the one or more processing elements to:
determine a set of timing offsets from the determined initial position representing different potential positions of the satellite along the predicted track of the satellite, and
determine a set of azimuth and elevation offsets representing different potential positions of the satellite off of the predicted track of the satellite; and
the computer-readable instructions that, when executed by the one or more processing elements, cause the feeder link terminal system to scan the ellipsoidal region for the satellite include computer-readable instructions that, when executed by the one or more processing elements, cause the one or more processing elements to apply the set of timing offsets and the set of azimuth and elevation offsets to scan the ellipsoidal region for the satellite.

20. The computer-readable storage medium of claim 16, wherein:
the computer-readable instructions that, when executed by the one or more processing elements, cause the processing elements to define the substantially ellipsoidal region to scan for the satellite include computer-readable instructions that, when executed by the one or more processing elements, cause the feeder link terminal system to:
determine a set of timing offsets from the determined initial position representing different potential positions of the satellite along the predicted track of the satellite, and
determine a set of azimuth and elevation offsets representing different potential positions of the satellite off of the predicted track of the satellite; and
the computer-readable instructions that, when executed by the one or more processing elements, cause the one or more processing elements to scan the ellipsoidal region for the satellite include computer-readable instructions that, when executed by the one or more processing elements, cause the one or more processing elements to apply the set of timing offsets and the set of azimuth and elevation offsets to scan the ellipsoidal region for the satellite.
